(19) United States
(12) Patent Application Publication
(10) Pub. No.: US 2005/0205617 A1
(43) Pub. Date: Sep. 22, 2005

(54) Fluid dispensing system and method with fluid scavenging

(76) Inventors: Yu-Sen James Chu, Westlake, OH (US); Shain E. Naugle, Sheffield Lake, OH (US)

Correspondence Address: Don W. Bulson, Esq.;Renner, Otto, Boisselle & Sklar, 1621 Euclid Ave. - 19th Floor, Cleveland, OH, 44115, US

(21) Appl. No.: 11/082,644

(22) Filed: Mar. 17, 2005

Related U.S. Application Data
(60) Provisional application No. 60/554,841, filed on Mar. 19, 2004.

(51) Int. Cl. B67B 7/00

(52) U.S. Cl. 222/529

(57) ABSTRACT

The present invention provides a fluid dispensing system and method wherein, after dispensing a fluid, a scavenging pump is used to remove (i.e., scavenge) residual fluid from the dispensing hose without encountering the drawbacks of the prior art. Another advantage is that the scavenging pump can be utilized for priming a main fluid supply used to supply fuel to the dispensing hose.

### RELATED APPLICATIONS

This application hereby incorporates by reference and claims the benefit of U.S. Provisional Application No. 60/554,841 filed Mar. 19, 2004.

### FIELD OF THE INVENTION

The present invention relates generally to a fluid dispensing system and method. More particularly, the invention relates to a fluid dispensing and scavenge system for dispensing fuel or other fluids and scavenging residual fluid from a dispensing hose.

### BACKGROUND OF THE INVENTION

Fluids, in particular fuels, are often dispensed using flexible dispensing hoses that typically are unwound from a reel in order to dispense fluid from a source tank to the tank to be filled, which may be a fuel tank of a vehicle, a radiator of a vehicle, etc. A valve or nozzle generally is provided on a dispensing end of the hose for controlling the flow of the fluid. To dispense fluid, a pump is activated to supply fluid to the dispensing hose for dispensing, and the valve is opened to allow the fluid to flow. When dispensing is complete, the valve is closed and the dispensing hose is retracted, such as by rewinding the hose onto the reel.

After dispensing a fluid, residual fluid often remains in the dispensing hose. If the dispensing hose is to be rewound on a reel, the residual fluid can make rewinding the dispensing hose difficult. A common practice to remove the residual fluid from a dispensing hose has been for the operator to raise the dispensing hose to allow the fluid to drain back to the source tank. Alternatively, the fluid has been drained from the dispensing hose to the environment. However, lifting the dispensing hose can be tiresome and tedious, and draining the dispensing hose into the environment wastes the fluid and/or can contaminate the environment.

### SUMMARY OF THE INVENTION

The present invention provides a fluid dispensing system and method wherein, after dispensing a fluid, a scavenging pump is used to remove (i.e., scavenge) residual fluid from the dispensing hose without encountering the drawbacks of the prior art. Another advantage is that the scavenging pump can be utilized for priming a pump used to supply fuel to the dispensing hose.

In accordance with one aspect of the invention, a fluid dispensing system and method are characterized by a dispensing hose, a main fluid supply for supplying fluid from an inlet to the dispensing hose for dispensing of the fluid at a dispensing end of the hose remote from the inlet, and a scavenging pump for scavenging fluid from the dispensing hose when fluid is no longer being dispensed from the hose.

In accordance with another aspect of the present invention, a fluid dispensing system comprises a main fluid supply for supplying fluid from an inlet to an outlet to which a dispensing hose can be connected, and a scavenging pump connectable to the outlet for scavenging fluid, whereby fluid can be scavenged from the dispensing hose through the outlet.

Further features of the invention will become apparent from the following detailed description when considered in conjunction with the drawings.

### DRAWINGS

FIG. 1 is a schematic diagram of a fluid dispensing system according to the present invention.

FIG. 2 is a schematic diagram of the fluid dispensing system of FIG. 1, illustrating operation thereof in a scavenge mode.

FIG. 3 is a schematic diagram of the fluid dispensing system of FIG. 1, illustrating operation thereof in a priming mode.

FIG. 4 is a schematic diagram of another embodiment of a fluid dispensing system according to the present invention.

### DETAILED DESCRIPTION

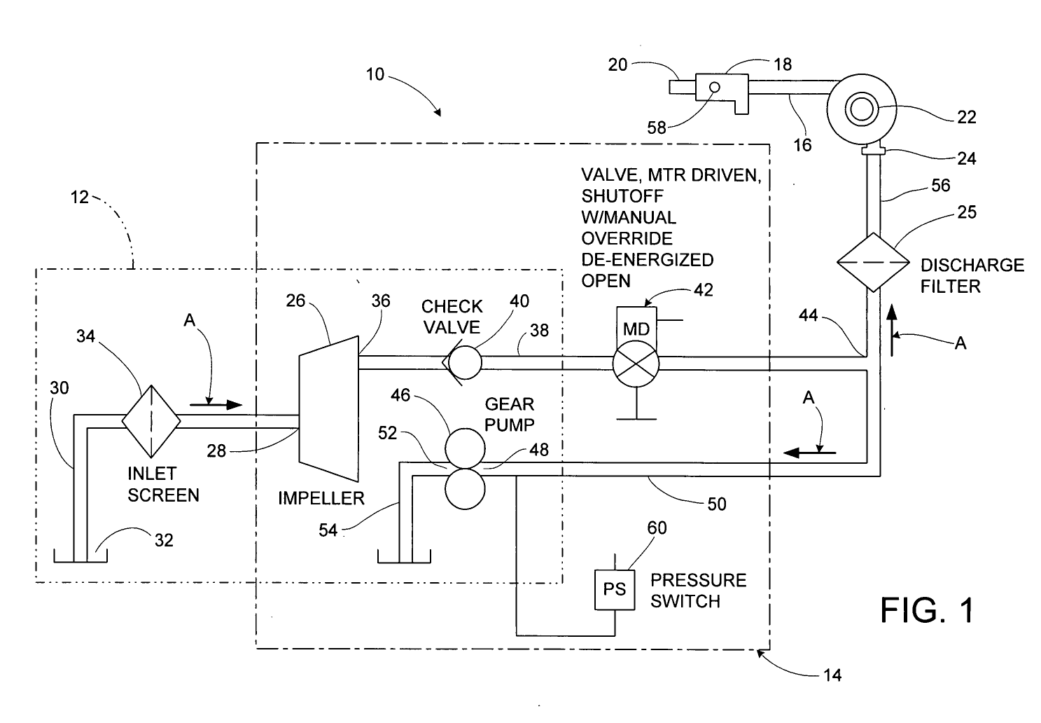

Referring now to the drawings in detail, and initially to FIG. 1, an exemplary fluid dispensing system 10 according to the invention will be described. The fluid dispensing system 10 generally comprises a tank 12, a pumping assembly 14 having an outlet 44, and a dispensing hose 16 connected to the outlet 44. The dispensing hose 16 is generally a collapsible hose and includes a nozzle 18 on a dispensing end thereof. The nozzle 18 includes a nozzle valve 20 which, when open as in FIG. 1, allows dispensing fluid for example into a tank, such as the fuel tank of a vehicle. A reel 22 is provided for storing and maintaining the collapsed dispensing hose 16 in an orderly fashion. A suitable fitting 24 connects the dispensing hose 16 to the pumping assembly 14. A discharge filter 25 can be provided to filter contaminants from the fluid prior to dispensing.

The pumping assembly 14 generally comprises a main pump 26 having a pump inlet 28 connected by piping 30 to an inlet 32 in communication with the interior of the tank 12. In general, any suitable type of pump can be used for the main pump 26. The inlet 32 typically is located near the bottom of the tank 12 and an inlet screen 34 can be provided between the inlet 32 and the pump inlet 28 for filtering contaminants from the fluid prior to the fluid entering the main fluid supply 26. A pump outlet 36 is connected via piping 38 to a pumping assembly outlet 44 to which the dispensing hose 16 is attached. A check valve 40 for preventing back-flow through the main pump 26 and a valve 42 are located between the pump outlet 36 and pumping assembly outlet 44.

In general, fluid is dispensed from the fluid dispensing system 10 by unwinding the dispensing hose 16 from the reel 22, inserting the nozzle 18 into the tank or other receptacle to be filled, activating the main pump 26 to supply fluid to the dispensing hose 16, and opening the nozzle valve 20 to allow the fluid to flow into the tank to be filled. In FIG. 1, arrows A indicate the fluid flow direction through the fluid dispensing system 10 during dispensing. When dispensing is complete, the nozzle valve 20 is closed, the main pump 26 is deactivated, and the dispensing hose is collapsed and rewound onto the reel 22.

It will be appreciated that residual fluid remains in the dispensing hose 16 after dispensing a fluid and must be removed to collapse the dispensing hose 16. As previously noted, an operator may lift the dispensing hose 16 to allow the fluid to drain back into the tank 12. Alternatively, the residual fluid may be discharged to the environment. However, lifting the dispensing hose 16 can be tiresome and tedious for an operator, and discharging the fluid to the environment wastes the fluid and/or can contaminate the environment.

In accordance with the present invention the pumping assembly 14 further comprises a scavenging pump 46 which in the illustrated embodiment is located inside the tank 12. The scavenging pump 46 has a scavenging pump inlet 48 connected to the pumping assembly outlet 44 via piping 50 and a scavenging pump outlet 52 connected via piping 54 to the interior of the tank 12. The scavenging pump 46 preferably is a positive displacement pump, but any suitable type of pump can be used. After dispensing a fluid, the scavenging pump 46 scavenges the residual fuel from the dispensing hose 16.

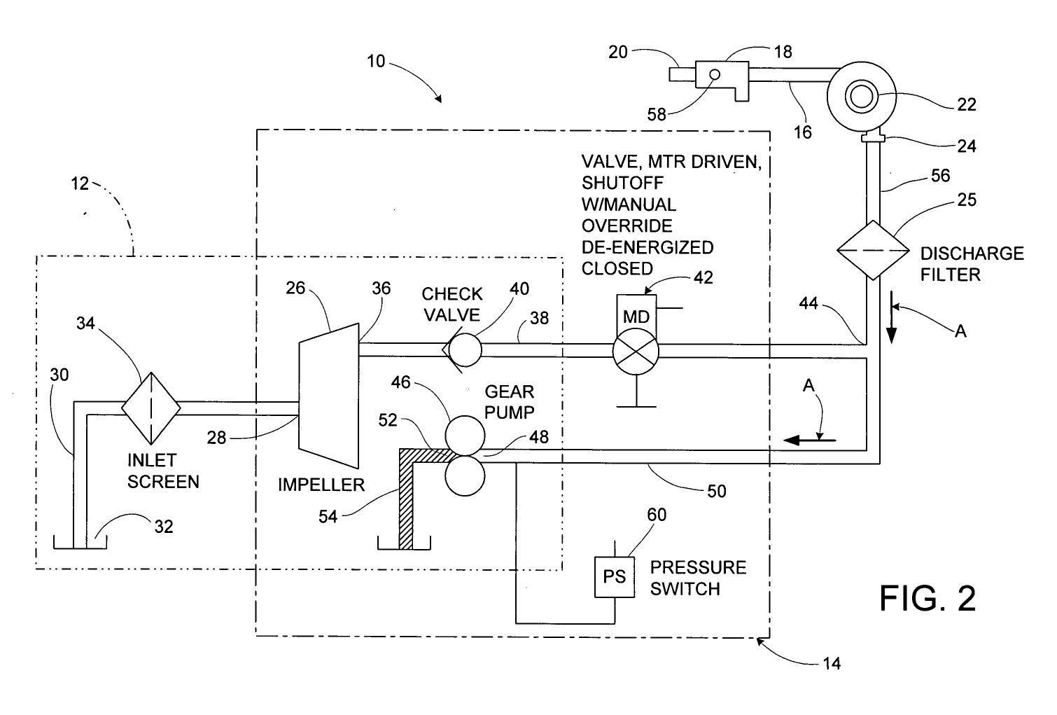

Turning to FIG. 2, in general scavenging the dispensing hose 16 is performed with the nozzle valve 20 and valve 42 closed. By closing the valve 42, fluid is prevented from flowing through the main pump 26. Thus, the scavenging pump 46 draws the residual fluid from the dispensing hose 16, as illustrated by arrow A. Preferably, the scavenged fluid is returned to the tank 12. Removal of the residual fluid from the dispensing hose 16 causes the dispensing hose 16 to collapse. Once the residual fluid is removed, the dispensing hose 16 can be rewound on the reel 22.

In some applications it is desirable to scavenge residual fluid from rigid or semi-rigid (i.e., non-collapsible) pipes 56 or dispensing hoses 16. It will be appreciated that in order to scavenge a non-collapsible pipe 56 or dispensing hose 16 with the scavenging pump 46, negative pressure in the system must be relieved to allow the residual fuel to be removed. One manner of relieving the negative pressure is to bleed air into the non-collapsible pipe 56 or dispensing hose 16. Therefore, a bleed valve 58 can be provided to allow air to enter the pipe 56 or dispensing hose 16. For example, in FIGS. 1-3, a bleed valve 58 is included on the nozzle 18 and allows air to enter the dispensing hose 16 during scavenging to relieve the negative pressure. Alternatively, the nozzle valve 20 can function as a bleed valve when opened by the operator during the scavenging process to allow air to enter the dispensing hose 16.

In general, when air is bled into the fluid dispensing system 10 to facilitate scavenging a non-collapsible pipe 56 or hose 16, the scavenging pump 46 is deactivated once the air reaches the scavenging pump 46 so as to limit the amount of air that is pumped into the tank 12. Typically, the operator may listen for the air to reach the scavenging pump 46 and manually shut off the scavenging pump 46 when the presence of air is detected. The scavenging pump 46 can also be switched off via a pressure switch 60 that detects the presence of air in or near the scavenging pump 46.

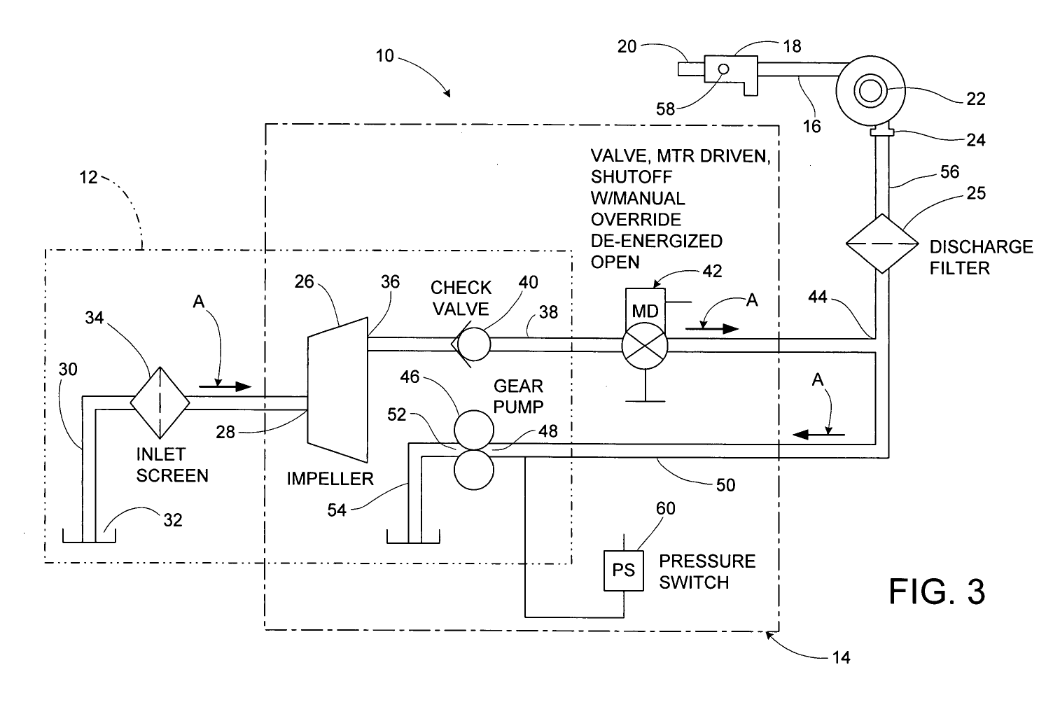

Turning to FIG. 3, it will be appreciated that the scavenging pump 46 can also be utilized to prime the main pump 26 prior to dispensing fluid from the dispensing hose 16. FIG. 3 is identical to FIG. 1 except that the nozzle valve 20 is closed. As shown by arrows A, when the scavenging pump 46 is activated with the nozzle valve 20 closed and the valve 42 open, fluid is drawn through the main pump 26 by the scavenging pump 46 and returned to the tank 12. In this manner, the scavenging pump 46 can prime the main pump 26.

It will now be appreciated that the main pump 26 and scavenging pump 46 can be configured to operate simultaneously. Thus, prior to dispensing, with the nozzle valve 20 closed and the valve 42 open, the main pump 26 and scavenging pump 46 can be activated together. In this configuration, the main pump 26 will be primed by the scavenging pump 46. To begin dispensing the fluid, the nozzle valve 20 is opened to allow fluid to flow therethrough. As mentioned, the valve 42 remains open during dispensing. The scavenging pump 46 can continue drawing fluid from the pumping assembly outlet 44 during dispensing. When dispensing is complete, the nozzle valve 20 and the valve 42 are closed, thereby causing the scavenging pump 46 to scavenge the residual fluid from the dispensing hose 16. Therefore, it will be appreciated that in the illustrated embodiment the closing and opening of the valve 42 effectively controls whether the scavenging pump 46 scavenges fluid from the dispensing hose 16 or primes the main pump 26. However, as desired the main pump 26 and the scavenging pump 46 can be operated independently.

In the embodiment of FIGS. 1-3, some of the components of the pumping assembly 14, including the main pump 26 and scavenging pump 46, are located within the tank 12. However, in other applications it can be desirable to have some or all of the components of the pumping assembly 14 located external to the tank 12.

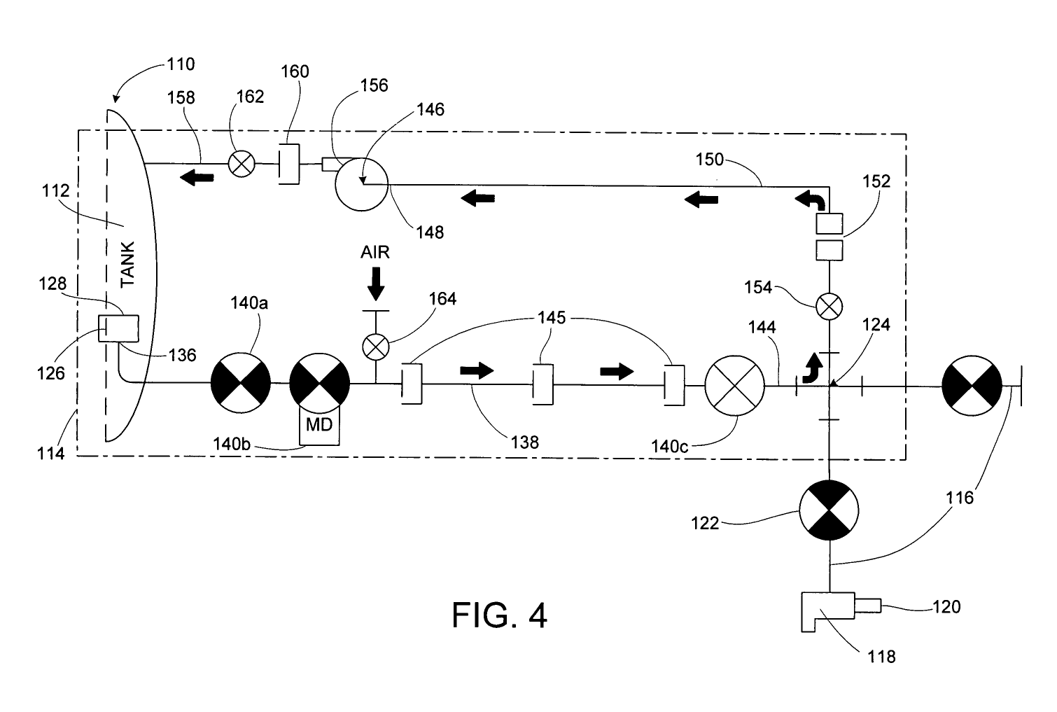

Turning to FIG. 4, a schematic of another embodiment in accordance with the present invention having the scavenging pump external to the tank will be described. The fluid dispensing system 110 generally comprises a tank 112, a fluid supply 114 having an outlet to which a dispensing hose can be connected, and two dispensing hoses 116. The dispensing hoses 116 are generally collapsible hoses and include nozzles 118 and nozzle valves 120 which, when open, allow dispensing fluid. A reel (not shown) can be provided for storing and maintaining the collapsed dispensing hoses 116 in an orderly fashion. Valves 122 can be provided to separately control flow to the dispensing hoses 116. A suitable union or fitting 124 connects the dispensing hoses 116 to the fluid supply 114.

The fluid supply 114 generally can include pump 126 located within the tank 112 and having a pump inlet 128 in communication with the interior of the tank 112. Alternatively, the fluid supply 114 can be a gravity feed for supplying fluid. As in the previous embodiment, any suitable type of pump can be used for the pump 126. A pump outlet 136 is connected via piping 138, and manual valves 140a, 140b, 140c to a fluid supply outlet 144. One or more of the valves 140a, 140b, 140c can be motor-driven valves. A plurality of unions 145 can also be provided as necessary to connect portions of the pipe 138. The fluid supply outlet 144 is connected to the fitting 124 to which the dispensing hoses 116 are connected.

The fluid supply 114 further comprises a scavenging pump 146 located outside the tank 112 and having a scavenging pump inlet 148 connected via piping 150 and union 152 to the fluid supply outlet 144 and/or the dispensing hoses 116. A valve 154 is provided on the fitting 124 side of the union 152 to control the flow of fluid from the fitting 124. A scavenging pump outlet 156 is connected via piping 158 and union 160 to the interior of the tank 112. A valve 162 is provided to control the flow of fluid from the tank 112. The unions 152 and 158 and valves 154 and 162 can be in the form or a quick-connect self-sealing valve thereby making installation and removal of the scavenging pump 146 from the fluid dispensing system 110 easier.

The operation of the fluid dispensing system 110 of the present embodiment is similar to the operation of the previously described embodiment. It will be appreciated that the scavenging pump 146 can also prime the pump 126 in a manner similar to the priming process described previously.

After dispensing is complete, the dispensing hoses 116 can be scavenged by the scavenging pump 146. To scavenge the dispensing hoses 116, the valve 140c is closed to prevent fuel from flowing through the outlet 144. Any residual fuel in the dispensing hoses 116 is scavenged by the scavenging pump 146 and returned to the tank 112. In general, collapsible dispensing hoses 116 are used and collapse upon removal of the residual fuel. However, in the case of a non-collapsible dispensing hose 116, a bleed valve (not shown) can be opened, or the nozzle valves 120 opened, to allow removal of the residual fuel in the manner described in connection with the previous embodiment.

The pipe 138 can also be scavenged by the scavenging pump 146 in the manner previously described in connection with scavenging non-collapsible pipes and hoses. In the present embodiment, a bleed valve 164 is provided on the pipe 138 to allow air to enter the pipe 138 at a location downstream from the valve 140b. To scavenge the pipe 138, valves 140a and/or 140b are closed and valve 140c remains open while the scavenging pump 146 is operated. Air is bled into the pipe 138 via bleed valve 164 thereby allowing the removal of the residual fuel. The bleed valve 164 can be a manual valve or an automatic valve that opens to permit air to enter the pipe 138 when a predetermined pressure is reached within the pipe 138.

It will be appreciated that the scavenging pump 146 in this embodiment can be attached and removed readily from the rest of the fluid dispensing system 110. Thus, the scavenging pump 146 can be attached to the system 110 when scavenging and/or priming is required, and detached when no longer needed. In this regard, it will be appreciated that with appropriate fittings and piping, the scavenging pump 146 can be retrofitted to existing fluid dispensing systems.

It further will be appreciated that any number of dispensing hoses 16, 116 can be used with the present invention. For example, the present invention can be used in conjunction with a mobile refueling vehicle wherein one or more large fuel tanks are mounted on a truck or other vehicle for dispensing fuel in remote locations. In such an application, multiple dispensing hoses 16, 116 can be provided. The priming and scavenging features of the present invention are particularly advantageous for mobile refueling because of the transient nature of the operation. For example, a truck may travel to a first location whereat several dispensing hoses may be used to fill multiple vehicles. These dispensing hoses are typically collapsible and stored on reels to save space and weight onboard the refueling vehicle. Thus, at each fueling location, the hoses must be unwound to dispense fuel and retracted onto the reels before the mobile refueling vehicle can depart to another fueling location. The scavenging feature of the present invention can make retracting and stowing the dispensing hoses more efficient. Further, the priming feature of the present invention can be of particular use for a mobile refueling operation because the main fluid supply may be more likely to require priming after transit, especially across rough terrain.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A fluid dispensing system comprising:
a dispensing hose;
a main fluid supply for supplying a fluid from an inlet to the dispensing hose for dispensing of the fluid at a dispensing end of the hose remote from the inlet; and
a scavenging pump for scavenging fluid from the dispensing hose when fluid is no longer being dispensed from the hose.

2. A fluid dispensing system as set forth in claim 1, wherein the main fluid supply is a pump.

3. A fluid dispensing system as set forth in claim 2, wherein the scavenging pump is configured to prime the pump.

4. A fluid dispensing system as set forth in claim 1, wherein the outlet hose is collapsible.

5. A fluid dispensing system as set forth in claim 1, wherein a bleed valve is provided at an end of the dispensing hose.

6. A fluid dispensing system as set forth in claim 1, wherein at least one of the main fluid supply and scavenging pump is located within a tank.

7. A fluid dispensing system as set forth in claim 1, wherein the scavenging pump is a positive displacement pump.

8. A method of dispensing a fluid from a dispensing hose comprising:
supplying the fluid with a main fluid supply from an inlet to the outlet hose for dispensing of the fluid at a dispensing end of the hose remote from the inlet; and
scavenging fluid from the outlet hose with a scavenging pump when fluid is no longer being dispensed from the hose.

9. A method as set forth in claim 8, wherein the supplying the fluid with a main fluid supply includes pumping the fluid with a pump.

10. A method as set forth in claim 9, further comprising priming the pump with the scavenging pump.

11. A method as set forth in claim 8, wherein the scavenging includes collapsing a collapsible dispensing hose.

12. A method as set forth in claim 8, wherein the scavenging further includes opening a bleed valve provided at an end of the dispensing hose.

13. A method as set forth in claim 8, wherein the fluid is a fuel.

14. A fluid dispensing system comprising:
a main fluid supply for supplying fluid from an inlet to an outlet to which a dispensing hose can be connected;
a scavenging pump connectable to the outlet for scavenging fluid;
whereby fluid can be scavenged from the dispensing hose through the outlet.

15. A fluid dispensing system as set forth in claim 14, further comprising a collapsible dispensing hose connected to the outlet for dispensing the fluid.

16. A fluid dispensing system as set forth in claim 14, wherein the main fluid supply is a pump.

17. A fluid dispensing system as set forth in claim 16, wherein the scavenging pump is configured to prime the pump.

18. A fluid dispensing system as set forth in claim 14, wherein at least one of the main fluid supply and scavenging pump is located within the tank.

19. A fluid dispensing system as set forth in claim 14, wherein the scavenging pump is a positive displacement pump.
